(19) United States
(12) Patent Application Publication
(10) Pub. No.: US 2004/0007516 A1
(43) Pub. Date: Jan. 15, 2004

(54) Water filter assembly

(76) Inventors: Karl Fritze, Denmark Township, MN (US); David M. Botts, Minnetrista, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/445,372

(22) Filed: May 23, 2003

Related U.S. Application Data
(60) Provisional application No. 60/383,187, filed on May 23, 2002.

(51) Int. Cl. B01D 15/00

(52) U.S. Cl. 210/263

(57) ABSTRACT

A water filter assembly allowing for uniform placement in refrigerators at the point of refrigerator manufacture, includes a self-contained unit, including a filter component, inlet and outlet connections, and water storage means all housed in one unit for placement, in its entirety, in the refrigerator during manufacture thereof with only a single point of inlet coupling to a refrigeration system of the refrigerator, the single point of coupling being to an internal refrigerator water supply. A method for uniform placement of a water filter assembly in refrigerators at the point of refrigerator manufacture is further included.

### RELATED APPLICATIONS

The present application claims the benefit of U.S. Provisional Application No. 60/383,187, filed May 23, 2002, and incorporated herein in its entirety by reference.

### FIELD OF THE INVENTION

The present invention relates generally to the field of water filtration systems mounted in a refrigerator. More specifically, the present invention relates to a self-contained water filtration apparatus adapted for quick and leak-free installation in a refrigerator.

### BACKGROUND OF THE INVENTION

Water filtration apparatuses are well known in the art. The necessity of water filtration for domestic use is increasing as population densities increase. Many municipal water supplies are contaminated with industrial and domestic pollutants that can adversely affect test or even render the water nonpotable. Further, in many rural areas, groundwater contains materials such as minerals giving the water an unpleasant appearance, taste and/ or odor.

Many portable filtration apparatuses such as U.S. Pat. No. 3,950,253 to Stern exist. The '253 apparatus is designed to be portable and is commercially used mainly on countertops. This type of system requires the user to continually refill the apparatus as the water reservoir only holds a finite amount of water and is not connected directly to a water supply.

Refrigerator mounted filter systems connected directly to a water supply exist. For example, Whirlpool® uses water filtration systems in their refrigerators. These systems can be as simple as individual filters placed on a water line, wherever the manufacturer can find space for them. This type of system is cumbersome for manufacturers to install. It requires water lines and components to be placed piecemeal throughput the refrigerator. Further, the components of the apparatus (i.e. filter, water reservoir, inlet/outlet valves) are fitted separately and in different locations throughout the refrigerator resulting in longer installations and an increased number of potential leak points.

These piecemeal systems must be assembled differently for each model and size of refrigerator. A self-contained unit that could be placed in a uniform position in any refrigerator would greatly improve upon the current filtration systems.

### SUMMARY OF THE INVENTION

The water filter assembly of the present invention is a self-contained unit, allowing for uniform placement in appliances, most typically refrigerators, at the point of manufacture. The water filter assembly of the present invention includes a filter component, inlet and outlet connections, and water storage means all housed in one unit. This unit can then be placed, in its entirety, in the refrigerator during manufacture.

The filter component may have multiple filtering configurations. One embodiment of the filter could be designed to only use granular activated carbon as the filter media. Another embodiment could use a series of pretreatment and post treatment filter media in conjunction with the granular activated carbon. Still other embodiments could involve garnet, anthracite, greensand, birm, calcite, softening resins, ion exchange media, microfabric, polymers ceramics, zeolyte, rhyolite or any other suitable filter media.

The inlet portion is in fluid communication with the refrigerator's water supply connection. The outlet portion may contain one or more outlet routes, one outlet may deliver drinking water, and another may supply water to an icemaker. The water filter assembly may contain a distribution manifold having valve controls to divert water to a particular outlet.

The water filter assembly may also include a flow sensor coupled to sensor electronics that measure flow.

The water storage means may be a simple tank. It may also be a predetermined length of tubing that holds a predetermined volume of water. This tubing system may act as a heat exchange system, for chilling water prior to dispensing.

The present invention is a water filter assembly allowing for uniform placement in refrigerators at the point of refrigerator manufacture is a self-contained unit, including a filter component, inlet and outlet connections, and water storage means all housed in one unit for placement, in its entirety, in the refrigerator during manufacture thereof with only a single point of inlet coupling to a refrigeration system of the refrigerator, the single point of coupling being to a refrigerator's water supply connection. The present invention is further a method for uniform placement of a water filter assembly in refrigerators at the point of refrigerator manufacture.

In one embodiment, the present invention is a water filter assembly that is easily placed within a refrigerator. The water filter assembly comprises a support structure containing components such as a filter component, inlet and outlet connections and a water storage vessel, all components in fluid communication with one another.

In another embodiment, the present invention is a method for assembling a self-contained water filter assembly designed for uniform placement in a refrigerator. The water filter assembly typically comprises a filter component, inlet and outlet connections and a water storage vessel. The water filter assembly is designed to be installed as a single unit within the refrigerator.

### BRIEF DESCRIPTION OF THE DRAWINGS

FIG. 1 is a schematic of an embodiment of the water filter assembly of the present invention;

FIG. 2 is a schematic representation of the water filter assembly of FIG. 1.

FIG. 3 is a schematic representation of an embodiment of a water filter assembly.

FIG. 4 is a schematic representation of an alternate embodiment having a plurality of cascaded filter elements.

FIG. 5 is a schematic representation of an embodiment of a water filter assembly.

FIG. 6 is a schematic representation of an embodiment of a water filter assembly.

FIG. 7 is a schematic representation of an embodiment of a water filter assembly.

FIG. 8 is a schematic representation of an embodiment of a water filter assembly.

FIG. 9 is a schematic representation of an embodiment of a water filter assembly.

FIG. 10 is a schematic representation of an embodiment of a water filter assembly.

FIG. 11 is a schematic representation of an embodiment of a water filter assembly.

FIG. 12 is a schematic representation of an embodiment of a water filter assembly.

FIG. 13 is a schematic representation of an embodiment of a water filter assembly.

FIG. 14 is a schematic representation of an embodiment of a water filter assembly.

FIG. 15 is a schematic representation of an embodiment of a water filter assembly.

### DETAILED DESCRIPTION OF THE DRAWINGS

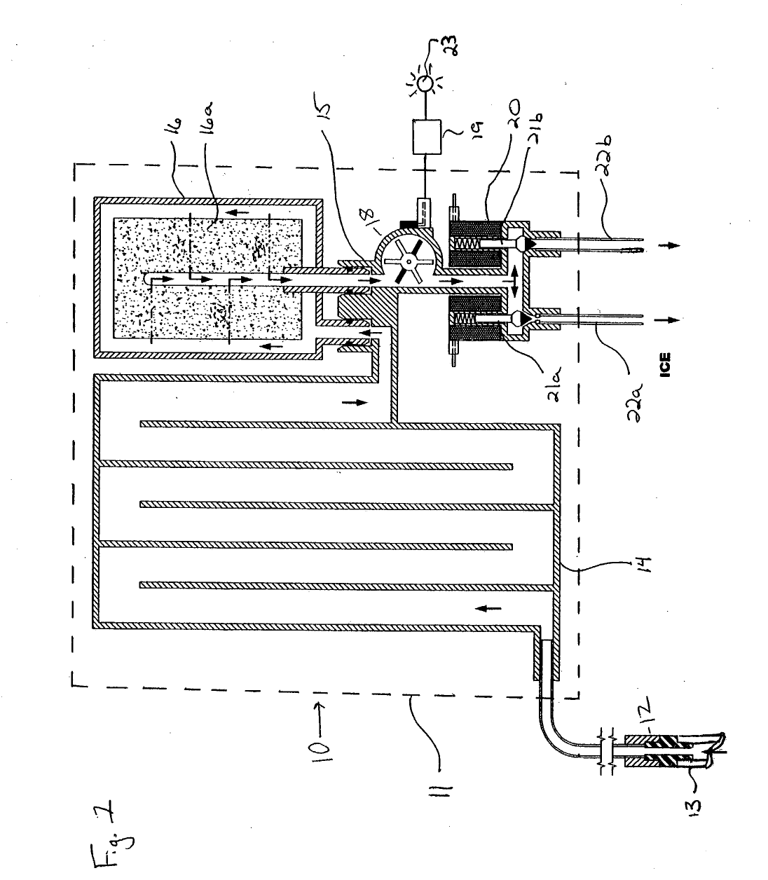

FIGS. 1 and 2 depict an embodiment of the water filter assembly 10. FIG. 2 is a schematic representation of assembly 10 shown in more detail in FIG. 1. Water filter assembly 10 comprises a support structure 11 onto which other components are assembled. Support structure 11 can be a housing, a rigid frame, or a flexible interconnection. Support structure 11 can provide for convenient attachment of a water filter assemble 10 into an appliance such as a refrigerator or the like. A housing can comprise a fully closed, box style assembly, an open frame assembly or the like while generally providing access for the replacement of spent, damaged or broken components. Other support structure 11 designs similarly maintain other components of water filter assembly 10 together as a unit. Support structure 11 can include a mounting surface for coupling the water filter assembly 10 within a refrigerator.

Water filter assembly 10 further comprises a water inlet 12 that connects to a water supply 13. Water inlet 12 typically comprises a length of plastic tubing for example tubing constructed of polypropyle, polyethylene, nylon and other suitable polymers. Water inlet 12 is in fluid communication with a water storage means 14. The water storage means 14 may have many configurations typically serving as a heat exchanger for supplying chilled, filtered water upon request. Water storage means 14 may be a tank or tanks. Water storage means 14 may also be a length of tubing which may or may not be serpentine or coiled to increase tubing length thus increasing retention volume. Water storage means 14 may include baffles, as shown in FIG. 1, to reduce or eliminate any water flow dead spots. Water storage means 14 can be constructed of metals such as aluminum or steel as well as plastic polymers such as polypropylene, polyethylene, nylon and other suitable polymers. The water storage means 14 is in fluid communication with an inlet side of a filter manifold 15.

Filter manifold 15 is connected to a filter element 16. Filter manifold 15 and filter element 16 can be rotatably connectable as disclosed in U.S. Pat. No. 6,027,644 and U.S. patent application Ser. Nos. 09/618,686, 09/929,920, 10/196,340, 10/202,290 and 10/406,637 or the connection can be slidably insertable as disclosed in U.S. patent application Ser. No. 10/210,890, all of which are commonly assigned to the assignee of the current invention and are hereby incorporated by reference in their entirety. Filter manifold can be an integral part of water storage means 14 for instance via a molding process or may be directly attachable to the exterior of water storage means 14. The filter element 16 may include any one or a combination of the following filter media: granular activated carbon, block activated carbon, garnet, anthracite, greensand, birm, calcite, softening resins, perforated absolute membrane or microfabric sheet, spun blown, ion exchange resins, polymers, ceramics, zeolyte, rhyolite or any other suitable filter media. Filter manifold 15 may include a flow sensor 18 on either an inlet or outlet side of the filter manifold 15 or integrally molded within filter manifold 15. As shown in FIG. 3, water filter assembly 10 can be constructed without flow sensor 18.

In addition or alternative to flow sensor 18, water filter assembly 10 may comprise various other sensors such as conductivity/resistivity, pH and temperature. A suitable sensor could include a bar code sensor to interface with a bar coding supplied with filter element 16, such that certain information such as date of manufacture or flow capacities can be determined. Flow sensor 18 can be wired to an electronics unit 19 an external unit such as a component of the refrigerator. Electronics unit 19 can be integral to water filter assembly 10 or can be an external unit such as a component of the refrigerator. Typically, electronics unit 19 comprises a microprocessor capable of interfacing with flow sensor 18. Electronics unit 19 can include a variety of performance and troubleshooting programs utilizing flow information supplied by flow sensor 18. Examples of these programs could including total flow, replacement schedules and current system status. Display unit 23 can include a liquid crystal display or similar display capable of displaying text messages regarding system status. Alternatively, display unit 23 can include a light or variety of lights for indicating status or required service. Water filter assembly 10 can also include a distribution manifold 20 for directing filtered water to desired point of use such as a drinking water dispenser or an icemaker through a plurality of water outlets 22a, 22b which can be two or more outlets. Distribution manifold 20 can include a plurality of solenoid valves 21 a, 21b which open and close based upon an input from the points of use. In alternative embodiments, distribution manifold 20 can include a single outlet with flow controlled by a single valve, such as a solenoid valve. In other embodiments, solenoid valves 21a, 21b may be wired to electronics unit 19 allowing for filter assembly 10 to be disabled if certain criteria, such as those monitored by flow sensor 18 such as total flow, water quality standards or filter life based on the manufacturing date, are outside acceptable levels.

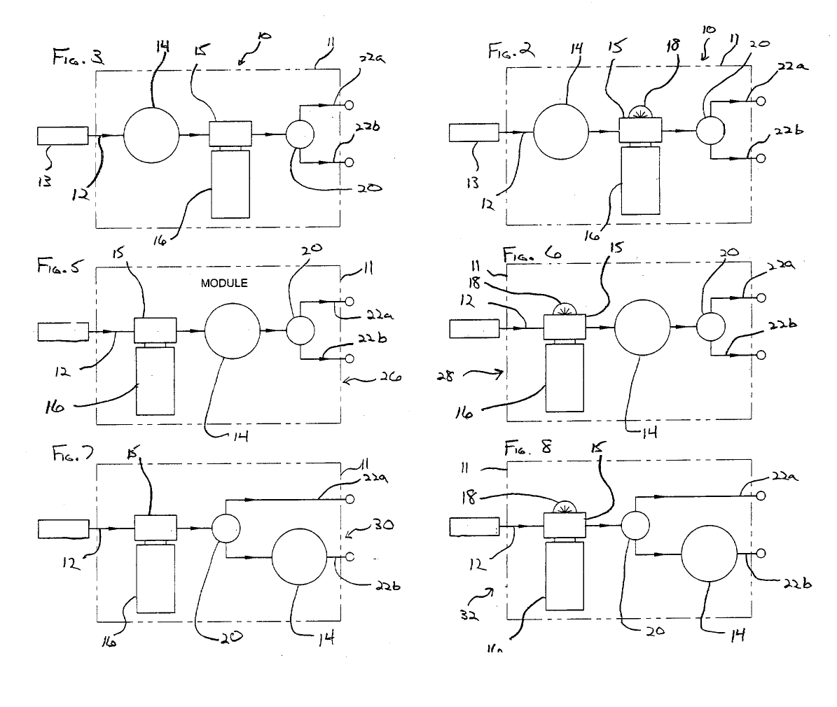

An alternate water filter assembly 15 is depicted in FIG. 4. Water filter assembly 15 makes uses of a filter element 16 having a plurality of replaceable filter elements 16a-16d. The filter elements 16a-16d are physically aligned and fluidly coupled in cascade, so that water flow passes sequentially through filter elements 16a-16d. The media of filter elements 16a-16d may be selected from the list above, as desired. The filter elements 16a-16d may be replaced one at a time or all together, as desired, by sliding each filter element 16a-16d out of and into the filter element housing 16. Element 16b may comprise the activated carbon with a plurality of pre and post filtering elements 16a and 16c, 16d, as desired.

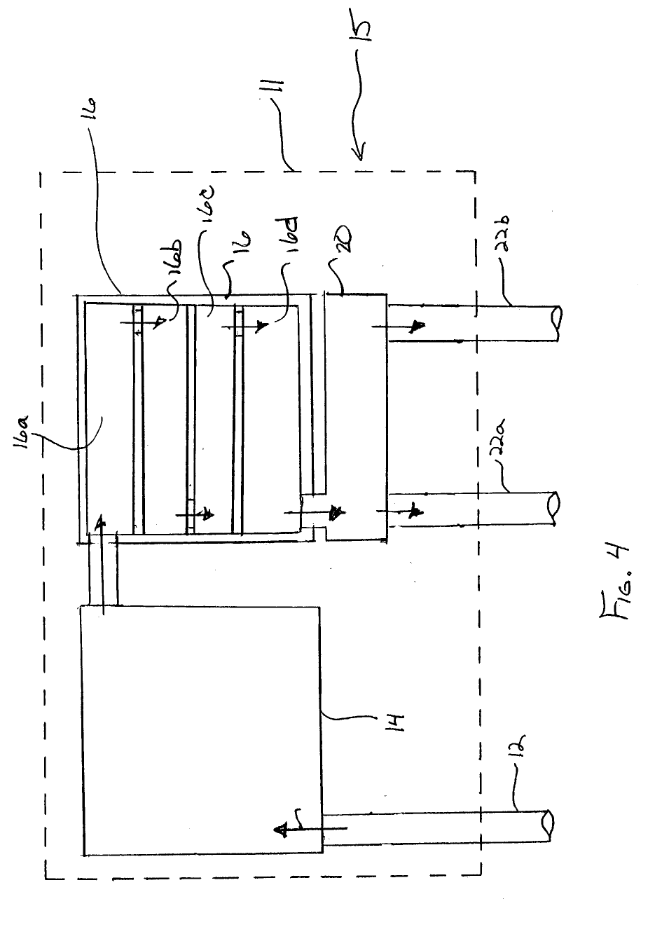

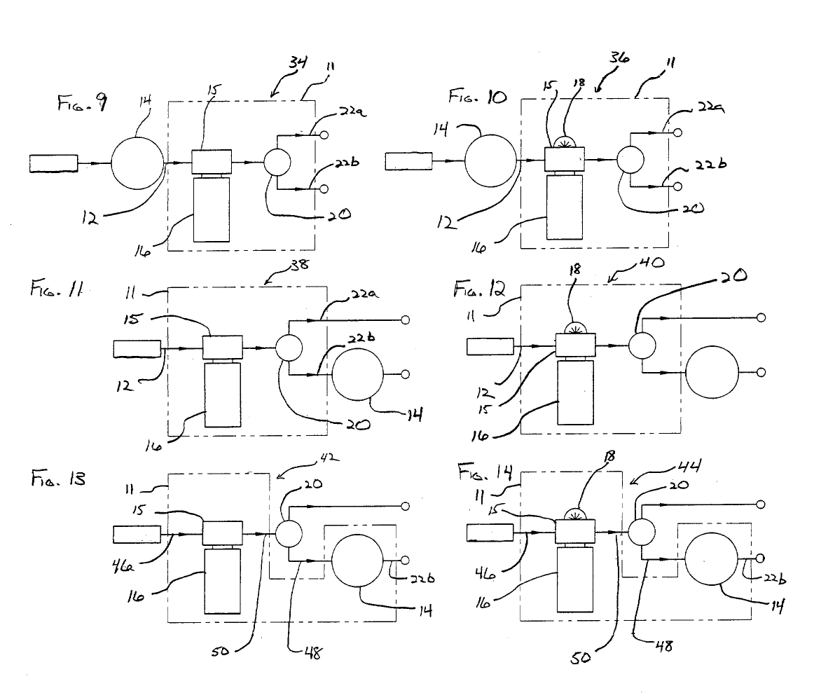

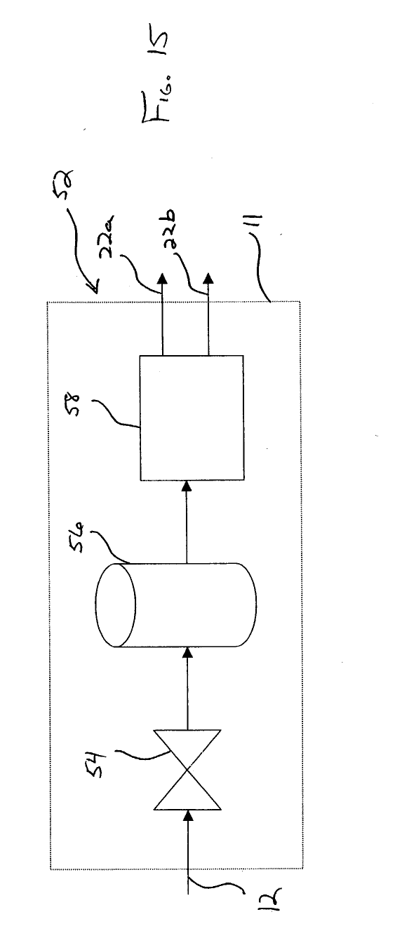

While FIGS. 1, 2, 3, and 4 depict convenient configurations of the assembly components, the components can be configured with alternative arrangements within the assembly. For example, FIGS. 5 and 6 depict alternative water filter assemblies 26 and 28 having different configurations of components. Each water filter assembly includes a support structure 11 and at least one water inlet 12 and outlets, such as outlets 22a, 22b. Water filter assembly 28 includes a sensor 18. FIGS. 7 and 8 depict alternative water filter assemblies 30 and 32 with a valve upstream from a storage tank. Each water filter assembly includes a support structure 11 and at least one water inlet 12 and outlets, such as outlets 22a, 22b. Water filter assembly 32 includes a sensor 18. FIGS. 9 and 10 depict alternative water filter assemblies 34 and 36 including an upstream storage tank that is not part of the assemblies. Each water filter assembly includes a support structure 11 and at least one water inlet 12 and outlets, such as outlets 22a, 22b. Water filter assembly 36 includes a sensor 18. FIGS. 11 and 12 depict alternative water filter assemblies 38 and 40 including a downstream storage tank that is not part of the assemblies. Each water filter assembly includes a support structure 11 and at least one water inlet 12 and outlets, such as outlets 22a, 22b. Water filter assembly 40 includes a sensor 18. FIGS. 13 and 14 depict alternative water filter assemblies 42 and 44. Water filter assemblies 42 and 44 include a valve that is not part of the assemblies and include a supply inlet 46 and a distribution inlet 48 as well as filtered outlet 50 and as well as outlet 22b. Water filter assembly 44 includes a sensor 18. Water filter assemblies 26, 28, 30, 32, 34, 36, 38, 40, 42 and 44 are representative of the types of modifications that can be made without departing from the spirit and scope of the present invention.

In FIG. 15, water filter assembly 52 includes a valve assembly 54 upstream of a filter assembly 56. From filter assembly 56, water flows to tank 58 into which outlets 22a, 22b are attached. Outlet 22a can be plumbed directly to an ice maker while outlet 22b can deliver filtered water to a drinking water dispenser or other points of use.

With respected to the embodiments shown and describe, additional configurations including multiple filter elements providing multiple filtering steps can be arranged in various sequential and non-sequential arrangements in the water filter assembly to achieve certain desired filtering levels such as the removal of chlorine, organics, total dissolve solids and the like.

In practice, the water filter assemblies of the present invention are assembled and tested prior to installation by the refrigerator manufacturer. When received by the manufacturer, water filter assembly 10 is positioned and support structure 11 is fixedly attached to the refrigerator. Attachment can be accomplished by a variety of means including screws, snap fittings, brackets and other suitable attachment means. Once support structure 11 is installed, all that generally is left for the refrigerator manufacturer is to attach inlet 12 to refrigerator water supply 13 and outlets 22a, 22b to the points of use. Replaceable components such as the filter element 16 and the like can be attached by the refrigerator manufacturer or the end user.

In actual use, water flows into the water filter assembly 10 through inlet 12. Water flows into storage means 14 where it may be prechilled prior to filtration and use. When either solenoid valve 21a or 21b opens based upon an input from the points of use, water begins flowing from storage means 14 and into filter element 16. Once filtered, the water exits the filter element 16 and passes over the flow sensor 18. The flow sensor 18 may be a paddle wheel, a turbine, a gear pump or any other suitable configuration to measure totality of water usage and/or flow rate. The sensor 18 is in communication with electronic unit 19 for receiving an output from the sensor 18. The electronics unit 19 can then transmit an output to display device 23 for alerting a user of current status and any actions that are required, such as changing the filter element 16. The filtered water then flows into the distribution manifold 20 and to point of use through outlet 22a or 22b.

While various embodiments of the present invention have been disclosed, it will be obvious to one skilled in the art that these embodiments are readily combinable and numerous water filter assembly embodiments are achievable.

What is claimed is:

1. A water filter assembly allowing for easy placement in an appliance, the water filter assembly comprising:
a self contained unit comprising a support structure, a filter component, inlet and outlet connections, and a water storage vessel all joined together for common placement in the refrigerator wherein the inlet connection is in fluid communication with a fluid channel through the filter and water storage vessel connecting ultimately with the outlet connection.

2. The water filter assembly of claim 1, filter component having multiple filtering configurations, one filtering configuration being to only use granular activated carbon as a filter media.

3. The water filter assembly of claim 2, including a series of pretreatment and post treatment filter media in conjunction with the granular activated carbon.

4. The water filter assembly of claim 3, including a series of pretreatment and post treatment filter media being selected from media consisting of garnet, anthracite, greensand, birm, calcite, softening resins, ion exchange media, microfabric, polymers, ceramics, zeolyte and rhyolite.

5. The water filter assembly of claim 1, including the outlet portion having at least one outlet route.

6. The water filter assembly of claim 4, including two water outlet routes, a first outlet for directly delivering filtered water to a user and a second outlet for delivering filtered water to an ice maker.

7. The water filter assembly of claim 1 having a distribution manifold, the distribution manifold having valve controls for selectively diverting water to a selected outlet.

8. The water filter assembly of claim 1 including a flow sensor couplable to sensor electronics for measuring at least a first selected flow parameter.

9. The water filter assembly of claim 8 wherein the flow sensor measures total usage.

10. The water filter assembly of claim 8 wherein the flow sensor measures flow rate.

11. The water filter assembly of claim 8 wherein the sensor electronics includes an output signal for alerting a user to take a known maintenance action with respect to the assembly.

12. The water filter assembly of claim 1 wherein the water storage means is a simple tank.

13. The water filter assembly of claim 1 wherein the water storage means is a predetermined length of tubing that holds a predetermined volume of water.

14. The water filter assembly of claim 1 wherein the water storage means acts as a heat exchange system for chilling water prior to dispensing.

15. A refrigerator comprising the water filter assembly of claim 1.

16. A method for uniform placement of a water filter assembly in a refrigerator, the method comprising:
assembling a self-contained water filter assembly unit, including a filter component, inlet and outlet connections, and a water storage vessel wherein the self-contained water filter assembly unit can be placed as a unit within the refrigerator and an inlet coupled to a water supply and at least one outlet coupled to at least one point of use.

17. The method of claim 16, including providing the filter component with multiple filtering configurations, one filtering configuration being to only use granular activated carbon as a filter media.

18. The method of claim 17, including providing a series of pretreatment and post treatment filter configurations in conjunction with the granular activated carbon.

19. The method of claim 18 including selecting the series of pretreatment and post treatment filter configurations from media consisting of garnet, anthracite, greensand, birm, calcite, softening resins, ion exchange media, microfabric and, polymers.

20. The method of claim 16, including providing two outlets, a first outlet for directly delivering filtered water to a user and a second outlet for delivering filtered water to an ice maker.

21. The method of claim 20 including selectively diverting water to a selected outlet by having a distribution manifold having at least one valve control.

22. The method of claim 16 further comprising measuring at least a first selected flow parameter by means of a flow sensor couplable to sensor electronics.

23. The method of claim 22 including measuring total usage by means of the flow sensor.

24. The method of claim 22 including measuring flow rate by the flow sensor.

25. The method of claim 22 including alerting a user to take a known maintenance action with respect to the assembly by means of the sensor electronics.

26. The method of claim 16 including providing a simple tank as the water storage vessel.

27. The method of claim 16 including providing a predetermined length of coiled tubing that holds a predetermined volume of water as the water storage vessel.

28. The method of claim 16 further comprising chilling water prior to dispensing by means of the water storage vessel acting as a heat exchange system.

29. A water filter assembly allowing for easy placement in an appliance, the water filter assembly comprising:
a self contained unit comprising a support structure, a filter assembly, and inlet and outlet connections, and
at least one component selected from the group consisting of: a water storage vessel, a distribution valve assembly and a water flow sensor,
wherein the filter assembly, inlet and outlet connections and at least one component are joined together for common placement in the appliance and the inlet connection is in fluid communication with a fluid channel through the filter and through the at least one component, connecting ultimately with the outlet connection.

30. A refrigerator comprising the water filter assembly of claim 29.
